(19) United States
(12) Patent Application Publication
(10) Pub. No.: US 2006/0052081 A1
(43) Pub. Date: Mar. 9, 2006

(54) Apparatus and method for displaying digital multimedia broadcasting channel information in a terminal

(75) Inventor: Young-Tack Cho, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/213,543

(22) Filed: Aug. 26, 2005

(30) Foreign Application Priority Data
Sep. 7, 2004 (KR) 71309/2004

(51) Int. Cl. H04Q 7/20; H04M 11/00

(52) U.S. Cl. 455/403

(57) ABSTRACT

An apparatus and a method for displaying digital multimedia broadcasting channel information in a terminal. The apparatus includes a first display unit for displaying the digital multimedia broadcasting channel information, a second display unit for displaying program information corresponding to a channel selected by a user, and a control unit for creating channel information based on electronic channel guide information extracted from a digital multimedia broadcasting signal, sending the channel information to the first display unit, and sending program information to the second display unit.

### PRIORITY

This application claims priority to an application entitled “Apparatus and Method for Displaying Digital Multimedia Broadcasting Channel Information in Terminal” filed in the Korean Intellectual Property Office on Sep. 7, 2004 and assigned Serial No. 2004-71309, the contents of which are incorporated herein by reference.

### BACKGROUND OF THE INVENTION

1. Field of the Invention

The present invention relates generally to a terminal for receiving digital multimedia broadcasting (DMB), and more particularly to an apparatus and a method, which display digital multimedia broadcasting channel information.

2. Description of the Related Art

Digital multimedia broadcasting (DMB) is a broadcasting service that transmits broadcasting content, thereby enabling subscribers to view or listen to various multimedia broadcasting services (video, audio, data, etc.) through multiple channels by means of a portable receiver or a vehicle receiver having a reception antenna.

While viewing the DMB through a mobile communication terminal, the user can select a desired broadcasting channel from broadcasting channel information displayed on a screen of the mobile communication terminal. The selected broadcasting channel may be displayed on a small portion in the screen. For example, the selected broadcasting channel may be displayed on a lower part of the screen in a small size, or may be displayed using overlapping characters on the screen.

FIG. 1 illustrates an example of broadcasting channel information displayed on a screen in a satellite television according to the prior art.

In order to display various broadcasting channel information (hereinafter, it is should be noted in the following description that the term ‘channel information’ represents a channel number or the name of a broadcasting station, and the term ‘program’ is used as a general term including a specific program and a commercial film (CF)) in the satellite television, a displayed program is deleted from the screen, and then, the broadcasting channel information is displayed on the screen. As a result, a user cannot view the displayed program but can view only the broadcasting channel information. In addition, even when performing a scroll function with respect to broadcasting channels, the user cannot view the program.

If a picture in picture (PIP) function is employed, the user may view the program. However, because the program is displayed in a small sized image, the user may be dissatisfied with the small sized image.

Referring to FIG. 1, reference sign ‘a’ represents an image of the broadcasting channel information, and reference sign ‘b’ represents an image of a program, which is being viewed by a user.

As described above, in the conventional technology, when checking the channel information, the user cannot view the image of the program, or the image of the program may be small. For example, when a user checks a broadcasting channel while viewing a drama program or a sports game program, an image of the drama program or the sports game program is stopped. In this case, the user may be dissatisfied with functions of devices.

### SUMMARY OF THE INVENTION

Accordingly, the present invention has been designed to solve the above and other problems occurring in the prior art.

An object of the present invention is to provide an apparatus and a method, which can display DMB channel information without having an influence on a currently displayed image of a program in a terminal.

Another object of the present invention is to provide an apparatus and a method, which can display DMB channel information and a program of a corresponding channel on two different display units of a terminal, respectively.

In order to accomplish the above and other objects, according to an aspect of the present invention, there is provided an apparatus for displaying digital multimedia broadcasting channel information in a terminal capable of receiving digital multimedia broadcasting. The apparatus includes a first display unit for displaying the digital multimedia broadcasting channel information, a second display unit for displaying program information corresponding to a channel selected by a user, and a control unit for creating channel information based on electronic channel guide information extracted from a digital multimedia broadcasting signal, sending the channel information to the first display unit, and sending program information to the second display unit.

According to another aspect of the present invention, there is provided a method for displaying digital multimedia broadcasting channel information in a terminal that can receive digital multimedia broadcasting and includes a first display unit and a second display unit. The method includes the steps of determining if electronic channel guide information exists in a memory, if digital multimedia broadcasting mode selection of a user is detected, if the electronic channel guide information exists, creating channel information by using the electronic channel guide information and displaying the channel information on the first display unit, and if the user selects a desired channel through the displayed channel information, detecting selection of the user and displaying a digital multimedia broadcasting program corresponding to the channel selected by the user on the second display unit.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates an example of satellite television broadcasting channel information displayed on a screen according to the prior art;

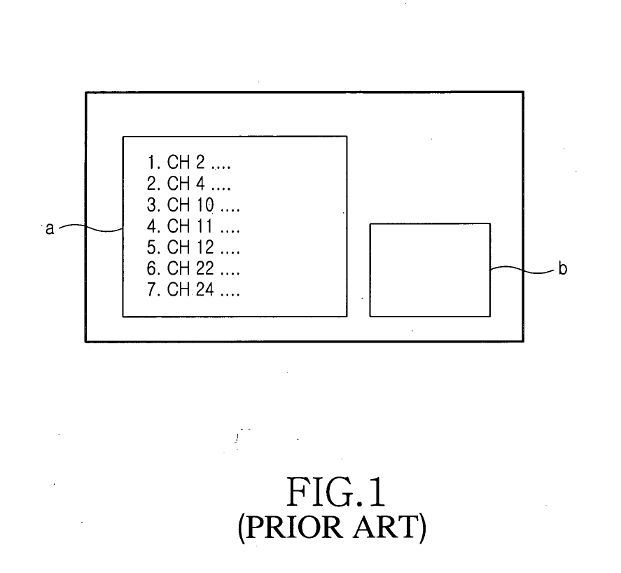

FIG. 2 is a perspective view illustrating a mobile communication terminal capable of receiving DMB according to an embodiment of the present invention;

FIG. 3 illustrates the DMB channel information displayed on a sub-LCD according to the present invention;

FIG. 4 is a block diagram illustrating a mobile communication terminal capable of receiving DMB according to an embodiment of the present invention;

FIG. 5 is a ladder diagram illustrating a method of displaying DMB channel information in the mobile communication terminal illustrated in FIG. 4;

FIG. 6 is a ladder diagram illustrating a method of displaying another DMB channel information in a mobile communication terminal illustrated in FIG. 4;

FIG. 7 is a ladder diagram illustrating a method of displaying still another DMB channel information in a mobile communication terminal illustrated in FIG. 4;

FIG. 8 is a block diagram illustrating a mobile communication terminal capable of receiving DMB according to another embodiment of the present invention;

FIG. 9 is a ladder diagram illustrating a method of displaying DMB channel information in a mobile communication terminal illustrated in FIG. 8; and

FIG. 10 is a ladder diagram illustrating a method of displaying another DMB channel information in a mobile communication terminal illustrated in FIG. 8.

### DETAILED DESCRIPTION OF THE PREFERRED EMBODIMENT

Hereinafter, preferred embodiments of the present invention will be described in detail with reference to the accompanying drawings. It is noted that the same or similar components in drawings are designated by the same reference numerals as far as possible although they are shown in different drawings. Also, hereinafter, specific items such as specific channel numbers, the name of a public broadcasting station, the name of a private broadcasting station, and the name of a program will be given. However, these specific items will be given only in order to understand the present invention. Accordingly, it is well known to those skilled in the art that the present invention can be realized without such specific items.

In the following description of the present invention, a detailed description of known functions and configurations incorporated herein will be omitted when it may obscure the subject matter of the present invention.

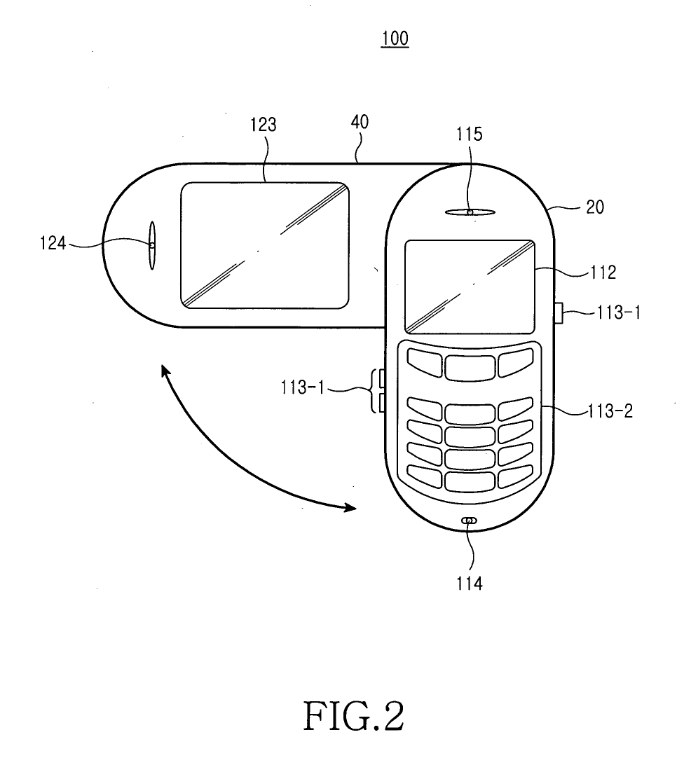

FIG. 2 is a perspective view illustrating a mobile communication terminal 100 capable of receiving a digital multimedia broadcasting (DMB) service according to an embodiment of the present invention. Herein, it is assumed that the mobile communication terminal illustrated in FIG. 2 is a cellular phone.

Referring to FIG. 2, the mobile communication terminal 100 includes a main body 20 and a sub body 40 that is connected to a lower part of the main body 20. The main body 20 includes a first display unit 112, a key input unit having a side key 113-1 and a keypad 113-2, a microphone 114, and a first speaker 115. The main body 20 is mainly used for performing functions relating to a portable telephone.

The sub body 40 includes a second display part 123 and a second speaker 124 and is mainly used for performing multimedia functions. Herein, although a rotary-type sub body 40 is illustrated, the sub body 40 can also be made up in a folder type. A coupling relationship between the main body 20 and the sub body 40 does not directly relate to the subject matter of the present invention.

Referring to FIG. 2, when the mobile communication terminal 100 is opened, i.e., when the main body 20 is not overlapped with the sub body 40, the first display unit 112 displays overall broadcasting channel information or channel information regarding a program (or a channel) being viewed by a user through the second display unit 123 according to selection of a user. When the sub body 40 is rotated and overlapped with the main body 20, i.e., the user can see only the first display unit 112, the channel information regarding the program (or the channel), which has been viewed by the user through the second display unit 123 until the sub body 40 is overlapped with the main body 20, is displayed on the first display unit 112 and corresponding DMB audio is output through the second speaker 124. Therefore, the user can know a program (or a channel) of the audio through the first display unit 112.

The mobile communication terminal 100 having the above-described structure performs functions relating to a portable telephone or functions for multimedia according to an operation of the user through the key input unit.

The user can view the DMB service through the second display unit 123, and the user can use either portable telephone functions or DMB channel information through the first display unit 112. Herein, the first display unit 112 and the second display unit 123 may be realized using a liquid crystal display (LCD).

In addition, if the second display unit 123 is a main display unit, the first display unit 112 may correspond to a sub display unit. For the purposes of description, the second display unit 123 and the first display unit 112 may be called a “main-LCD” and a “sub-LCD”, respectively.

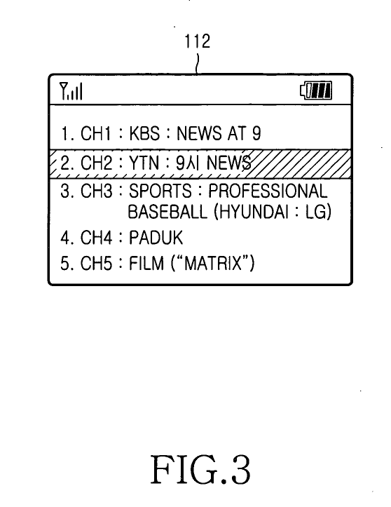

FIG. 3 illustrates DMB channel information displayed on the sub-LCD according to the present invention. That is, the DMB channel information illustrated in FIG. 3 is displayed on the first display unit 112, which is the sub-LCD, illustrated in FIG. 2.

Referring to FIG. 3, if the user presses a channel key (not shown, a user interface unit for setting a channel may be called the channel key, or a predetermined key may be previously set to a corresponding function) while viewing a DMB service through the second display unit 123, which is a main-LCD, various channel information is displayed on the first display unit 112. The user can see the displayed channel information by using an up/down key (not shown). If the user selects desired channel information from the channel information and switches over to the selected channel, an image on the second display unit 123 is changed. Herein, switching over to the desired channel is achieved by pressing a predetermined key (e.g., confirmation key).

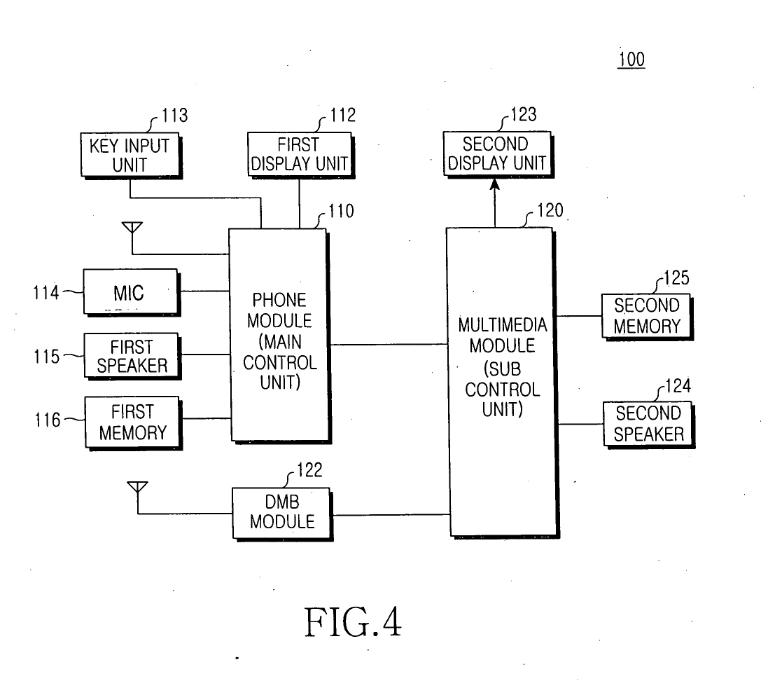

FIG. 4 is a block diagram illustrating the mobile communication terminal 100 capable of receiving a DMB service according to an embodiment of the present invention. Referring to FIG. 4, it is assumed that a first module (a phone module 110), a second module (a DMB module 122), and a third module (a multimedia module 120) are separated from each other. However, all or a portion of three modules may be included in one chip (a control unit).

The mobile communication terminal 100 according to the first embodiment of the present invention may include a portable telephone capable of receiving a DMB service. The mobile communication terminal 100 may include a portable telephone function module (called a phone module) 110 for controlling a portable telephone function, a DMB module 122 for performing a broadcasting service receiving function, and a multimedia module 120 for controlling a multimedia function. The phone module 110 controls the first display unit 112, the key input unit 113, the microphone 114, the first speaker 115, and a first memory 116. The multimedia module 120 controls the second display unit 123, the second speaker 124, and a second memory 125.

The phone module 110 may be realized using radio frequency (RF) transmission/reception unit and a modem chip (e.g., a QualComm MSM 5500 modem chip). The phone module 110 transmits/receives signals relating to communication and controls mobile communication terminal functions including portable telephone functions. The first display unit 112 displays information regarding the mobile communication terminal functions including the portable telephone functions and DBM channel information according to the present invention. The key input unit 113 receives data or a control command according to a user's operation. The microphone 114 receives audio signals. The first speaker outputs audio signals (e.g., voice in communication) relating to the portable telephone functions. The first memory 116 stores information regarding the overall mobile communication terminal functions including the portable telephone functions.

The DMB module 122 includes a unit for receiving a DMB RF signal through an antenna and a demodulator, which are not shown in the drawings because the subject matter according to the present does not lie in such a detailed construction.

The multimedia module 120 decodes DMB data sent from the DMB module 122 into multimedia information (image, letters, and audio), and outputs the multimedia information to a user. The second display unit 123 displays an image signal output from the multimedia module 120. The second speaker 124 outputs an audio signal output from the multimedia module 120. The second memory 125 stores information regarding a DMB service. The channel information may be stored in the second memory 125.

The second speaker 124 and the second display unit 123 are interface units for outputting the DMB service. Accordingly, only one of a speaker and a display unit may be employed according to DMB types. For example, when only a digital audio broadcasting service is provided, only a speaker is employed. In addition, the second speaker 124 may have a stereo function.

The first speaker 115, the second speaker 124, the first display unit 112, and the second display unit 123 may be constructed either as separate hardware or one integrated speaker and one integrated display unit. In addition, the multimedia module 120 may be realized by using an H.264 codec multimedia processor.

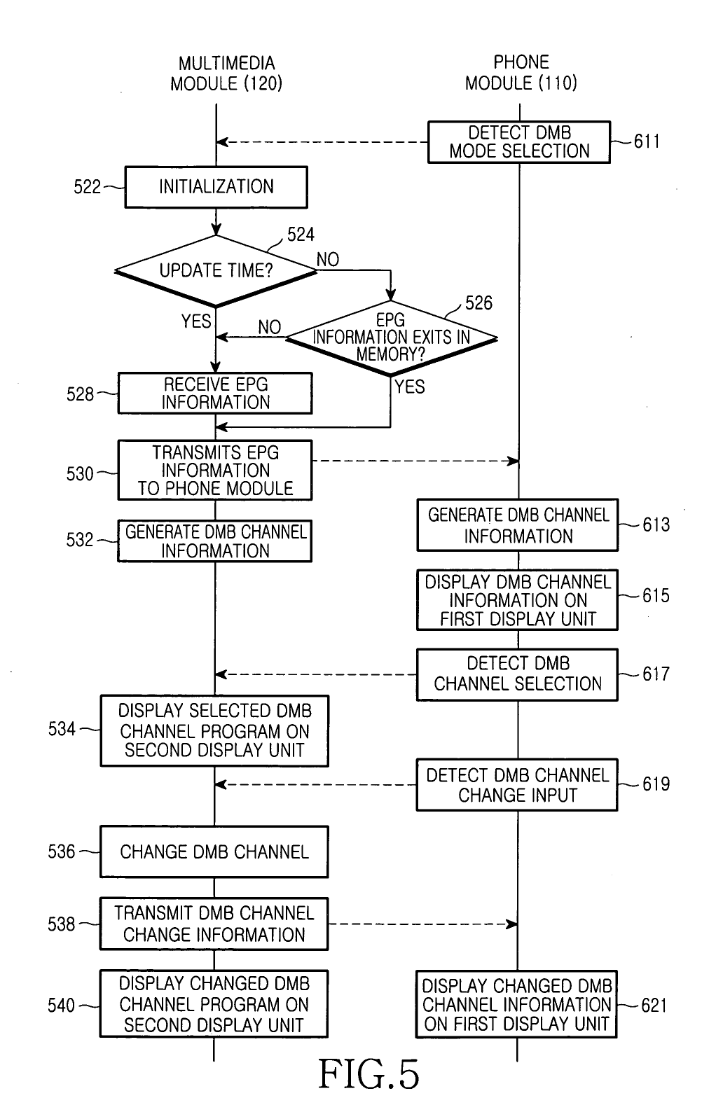

FIG. 5 is a ladder diagram illustrating a method of displaying DMB channel information in the mobile communication terminal illustrated in FIG. 4.

Referring to FIG. 5, if a user selects a DMB mode, the phone module 110 detects it in step 611. Then, the phone module 110 notifies the multimedia module 120 of the selection of the DMB mode.

Upon recognizing the selection of the DMB mode, the multimedia module 120 performs initialization in step 522. In step 524, the multimedia module 120 determines if it is time to update electronic program guide (EPG) information. If it is time to update electronic program guide (EPG) information, the multimedia module 120 receives EPG information in step 528. However, if it is not the time to update EPG information, the multimedia module 120 determines if EPG information exists in the second memory 125 in step 526. Herein, the EPG information does not exit in the second memory 125 when the multimedia module 120 is in an initial state or when a user intentionally removes the EPG information from the second memory 125 (the user can remove the EPG information from the second memory 125 whenever the user wants to update the EPG information).

If the multimedia module 120 determines that the EPG information does not exist in the second memory 125 in step 526, the multimedia module 120 performs step 528 so as to receive EPG information. Herein, progress toward step 528 from step 524 through step 526 are performed n response to match with a user's requirement (selection of the DMB mode) even though the EPG information does not exist in the second memory 125 and it is not time to update the EPG information.

If the EPG information exists in the second memory 125 in step 526, or if the multimedia module 120 receives the EPG information in step 528, the multimedia module 120 transmits the EPG information to the phone module 110 in step 530.

In step 532, the multimedia module 120 generates DMB channel information on the basis of the EPG information and stores the DMB channel information in the second memory 125. As described above, the reason for determining if it is time to update the EPG information is that the contents and the structure of the EPG information may be changed in a predetermined time. Herein, a broadcasting provider can determine the predetermined time. The broadcasting provider can periodically send changed EPG information and the sent EPG information can be periodically transmitted to the phone module 110.

Upon receiving the EPG information, the phone module 110 generates a DMB channel menu in step 613. In step 615, the phone module 110 displays DMB channel information on the first display unit 112. The DMB channel information image illustrated in FIG. 3 is an example of a DMB channel information image displayed in step 615. Herein, if the user selects a required channel through the displayed DMB channel information, the phone module 110 detects selection of a channel in step 617 and notifies the multimedia module 120 of channel information selected by the user.

Upon receiving the channel information selected by the user, the multimedia module 120 displays a program on the DMB channel according to selection of the user on the second display unit 123 in step 534.

Steps 536, 538, 540, 619, and 621, which will be described below, may be performed or not. That is, if the user does not intend to change the channel, steps 536, 538, 540, 619, and 621 are not performed.

If the user viewing the DMB channel program through the above described operations intends to view another DMB channel program and selects another DMB channel by pressing a channel key, the phone module 110 detects an input for changing a DMB channel and notifies the multimedia module 120 of a change of the DMB channel in step 619. For example, if the user selects channel ‘10’, the phone module 110 sequentially transmits ‘1’ and ‘0’ to the multimedia module 120.

The multimedia module 120 determines if the input for changing the DMB channel is valid. If the input for changing the DMB channel is valid, the multimedia module 120 changes a channel in step 536. Herein, the determination is necessary because the user may input an erroneous channel number.

The multimedia module 120 transmits DMB channel change information to the phone module 110 in step 538. In addition, the multimedia module 120 displays a program on the changed DMB channel on the second display unit 123 in step 540.

Upon receiving the DMB channel change information, the phone module 110 displays the changed DMB channel information on the first display unit 112 in step 621.

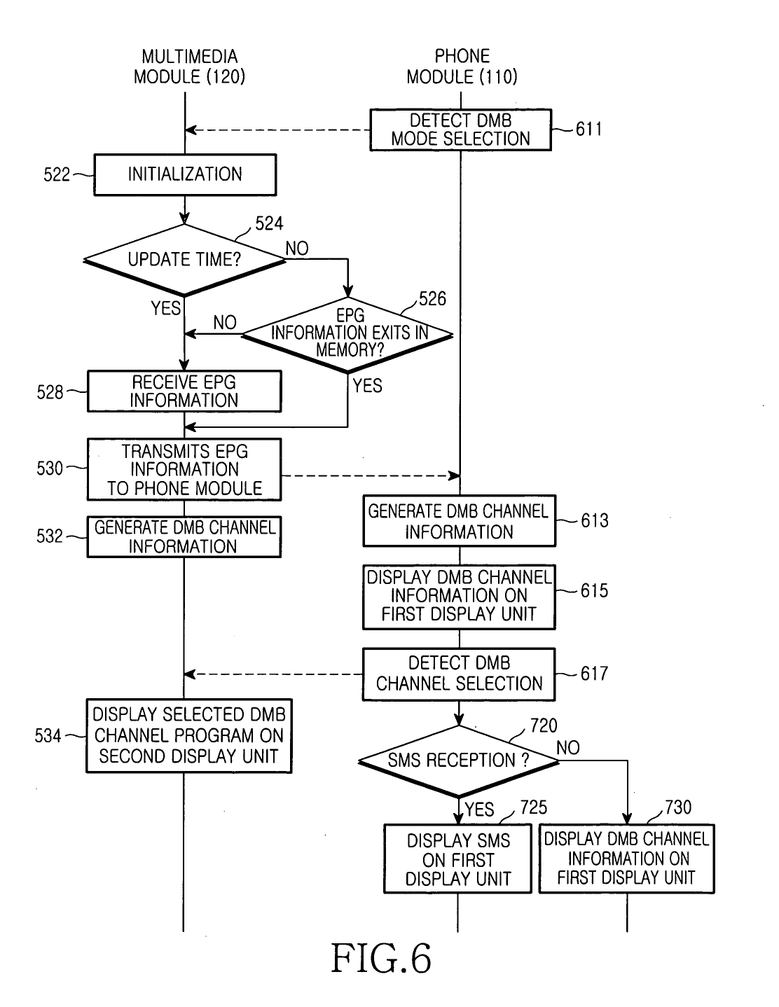

FIG. 6 is a ladder diagram illustrating another method of displaying DMB channel information in the mobile communication terminal illustrated in FIG. 4. In comparison with FIG. 5, the ladder diagram illustrated in FIG. 6 does not include steps 536, 538, 540, 619, and 621 (these steps are not shown in FIG. 6, because these steps are selectively performed). The ladder diagram illustrated in FIG. 6 additionally includes steps 720, 725, and 730 after step 617, and these steps are performed in order to receive a short message service (SMS) message during viewing of a DMB service.

Referring to FIG. 6, the phone module 110 displays DMB channel information on the second display unit 123 in step 615, and then, determines if an SMS message is received. Although step 720 is performed after step 617, it is unnecessary to keep this order. If the SMS message is received, the phone module 110 displays an SMS image on the second display unit 123 in step 725. However, if the SMS message is not received, the phone module performs step 730 to maintain a state in which the DMB channel information is displayed on the second display unit 123.

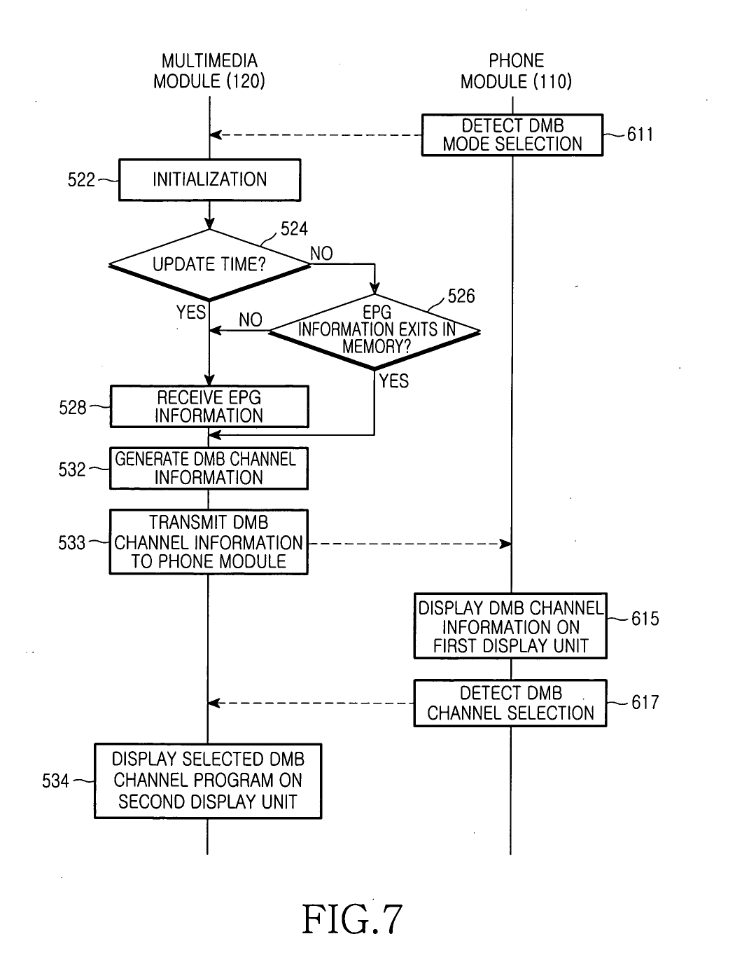

FIG. 7 is a ladder diagram illustrating another method of displaying DMB channel information in the mobile communication terminal illustrated in FIG. 4. In comparing FIG. 7 and FIG. 5, the multimedia module 120 does not transmit EPG information to the phone module 110, but generates DMB channel information in step 532 to transmit the generated DMB channel information to the phone module 110 in step 533. Therefore, the phone module 110 does not additionally generate it's own DMB channel information, and can use data provided by the multimedia module 120. That is, the phone module 110 displays the DMB channel information provided by the multimedia module 120 on the first display unit 112 in step 615. Operations of the other steps that are not described above are identical to those of the corresponding steps illustrated in FIG. 5.

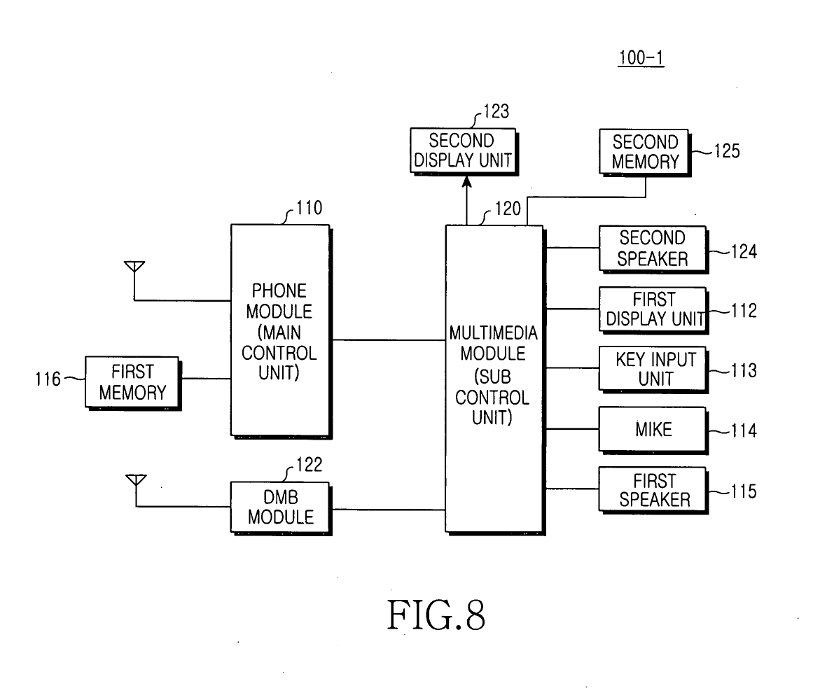

FIG. 8 is a block diagram illustrating a mobile communication terminal 100-1 capable of receiving digital multimedia broadcasting according to another embodiment of the present invention.

Referring to FIG. 8, the mobile communication terminal 100-1 according to the second embodiment of the present invention includes a personal data assistant (PDA) capable of receiving digital multimedia broadcasting. In comparing components illustrated in FIGS. 4 and 8, components under the control of the phone module 110 in FIG. 4, excluding the first memory 116, are controlled by the multimedia module 120 in FIG. 8. This structure is based on a structure of the PDA.

An operation of each component illustrated in FIG. 8 according to the present is identical to that of a corresponding component illustrated in FIG. 4, except for basic functions of the PDA. Accordingly, detailed description about each component will be omitted and the same reference numerals will be employed.

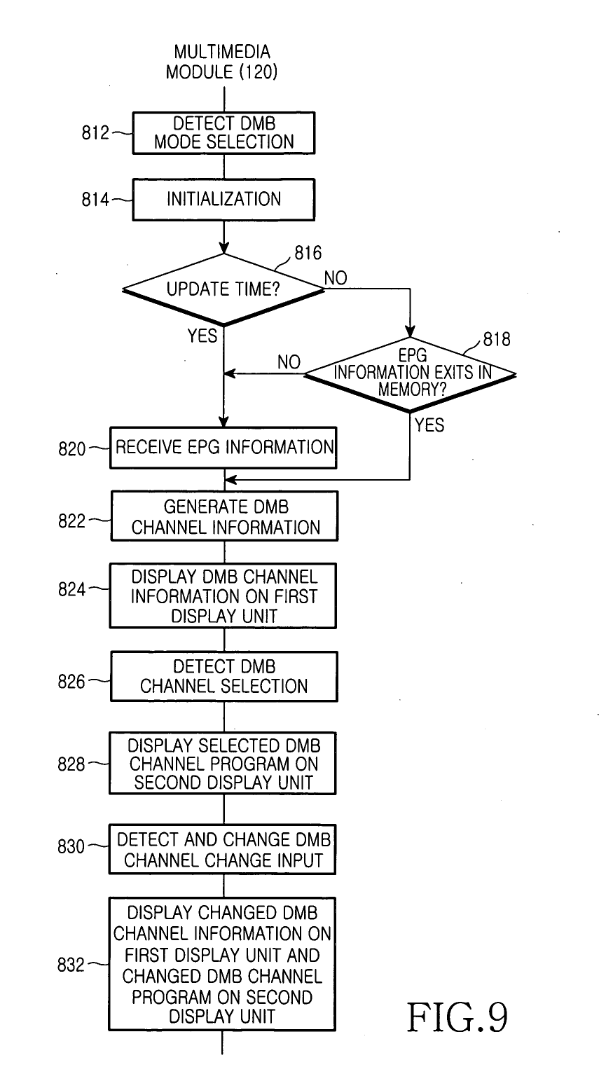

FIG. 9 is a ladder diagram illustrating a method of displaying DMB channel information in the mobile communication terminal illustrated in FIG. 8. Referring to FIG. 9, if a user selects a DMB mode, the multimedia module 120 detects selection of the DMB mode in step 812 and performs initialization in step 814. The multimedia module 120 determines if it is time to update EPG information in step 816. As described above, the reason determining if it is time to update the EPG information is that the contents and the structure of the EPG information may be periodically changed.

If it is time to update the EPG information, the EPG information is received in step 820. However, if it is not time to update the EPG information, the multimedia module 120 determines if the EPG information exits in the second memory 125 in step 818. Herein, when the multimedia module 120 is in an initial state or when a user intentionally removes the EPG information from the second memory 125, the EPG information does not exit in the second memory 125.

If the multimedia module 120 determines that the EPG information does not exist in the second memory 125 in step 818, the multimedia module 120 performs step 820 to receive EPG information. Steps 816 through 818 are performed in order to match with a user's requirement (selection of the DMB mode) even though the EPG information does not exist in the second memory 125 and it is not time to update the EPG information.

If the multimedia module 120 determines that the EPG information exists in the second memory 125 in step 818, or if the multimedia module 120 receives the EPG information in step 820, the multimedia module 120 performs step 822 to generate DMB channel information on the basis of the EPG information.

The multimedia module 120 displays the generated DMB channel information on the first display unit 112 in step 824. The DMB channel information screen illustrated in FIG. 3 is an example of the DMB channel information screen displayed in step 824. Herein, if the user selects a desired channel through the displayed DMB channel information, the multimedia module 120 detects selection of the user in step 826 and displays a program on a DMB channel according to selection of the user on the second display unit 123 in step 828.

Steps 830 and 832, which will be described below, are optionally performed. That is, if the user does not intend to change the DMB channel, steps 830 and 832 are not performed.

If the user viewing the DMB channel program displayed on the second display unit 123 intends to view another DMB channel program and selects another DMB channel by pressing a channel key, the multimedia module 120 detects an input for changing the DMB channel in step 830 and determines if the input for changing the DMB channel is valid. If the input for changing the DMB channel is valid, the multimedia module 120 changes the DMB channel in step 830 and displays a program on a changed DMB channel on the second display unit 123.

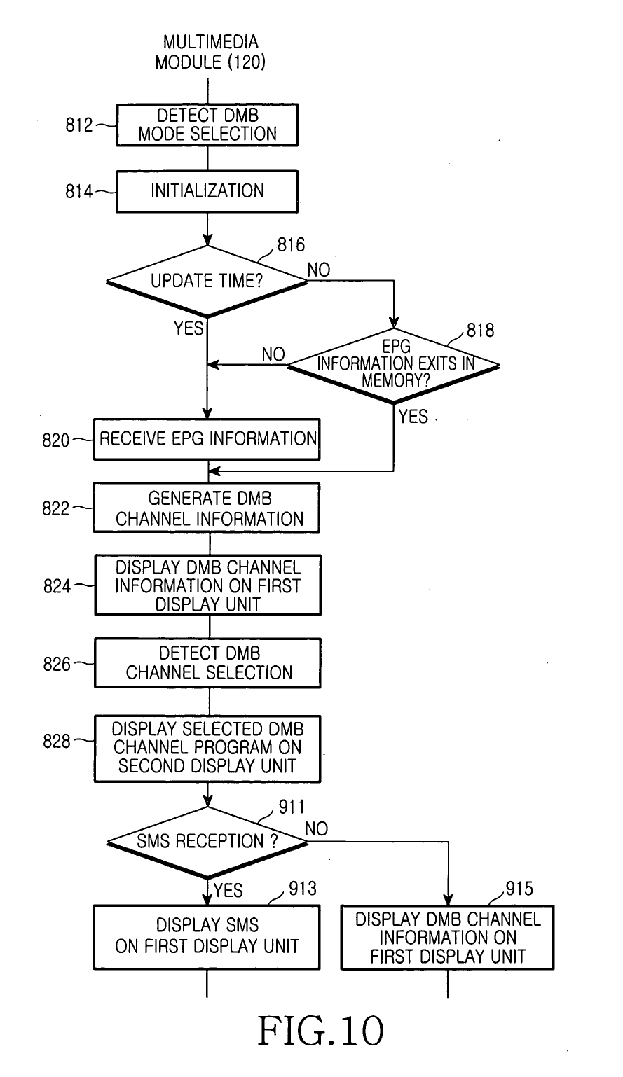

FIG. 10 is a ladder diagram illustrating another method of displaying DMB channel information in the mobile communication terminal illustrated in FIG. 8. In comparison with FIG. 9, steps 812 to 828 in FIG. 10 perform the same operations as those in FIG. 9, and steps 911, 913, and 915 are added to steps 812 to 828. Herein, steps 911, 913, and 915 are performed in relation to an SMS message while a user is viewing a DMB service displayed on the second display unit 123 according to step 828.

When a program on a DMB channel is displayed on the second display unit 123 in step 828, the multimedia module 120 determines if notification of SMS message reception is received from the phone module (not shown). If an SMS message is received, the multimedia module 120 displays an SMS message on the first display unit 112 in step 913. However, if the SMS message is not received, the multimedia module 120 performs step 915 to maintain the DMB channel information on the first display unit 112.

Similar to the procedure illustrated in FIG. 9, the operation illustrated in FIG. 10 may include steps 830 and 832. In this case, step 911 may be performed after step 828.

Procedures for both an SMS message and display thereof have been described with reference to FIGS. 6 to 10 by way of example. In addition, the same procedures may be employed for different types of messages and display thereof.

According to embodiments of the present invention, although a cellular phone or a PDA is employed, an MP3 player having at least two display units (e.g., a portable multimedia player (PMP) formed by coupling a portable MP3 player with an LCD screen which is a multimedia player), a digital video disc (DVD) player, or a terminal for Telemetics may be employed. In this case, a multimedia module may be realized in such a manner that the multimedia module processes basic operations for controlling MP3 play, DVD play, or Telemetics and operations (e.g., channel selection or change, program display, etc.) for receiving digital multimedia broadcasting services, or may be realized as an additional function module.

As described above, according to the present invention, a user can select a desired channel using channel information, thereby changing a channel without interrupting a DMB service while viewing the DMB service.

While the present invention has been shown and described with reference to certain preferred embodiments thereof, it will be understood by those skilled in the art that various changes in form and details may be made therein without departing from the spirit and scope of the present invention. Consequently, the scope of the invention should not be limited to the embodiments, but should be defined by the appended claims and equivalents thereof.

What is claimed is:

1. An apparatus for displaying digital multimedia broadcasting channel information in a terminal capable of receiving digital multimedia broadcasting, the apparatus comprising:
a first display unit for displaying the digital multimedia broadcasting channel information; and
a second display unit for displaying program information corresponding to a channel selected by a user.

2. The apparatus as claimed in claim 1, further comprising a control unit for creating channel information based on electronic channel guide information extracted from a digital multimedia broadcasting signal, sending the channel information to the first display unit, and sending program information: to the second display unit.

3. The apparatus as claimed in claim 2, further comprising a memory for storing the extracted electronic channel guide information, wherein, if the user selects a digital multimedia broadcasting mode, the electronic channel guide information is read from the memory and the channel information is generated.

4. The apparatus as claimed in claim 3, wherein, if the electronic channel guide information is not stored in the memory, new electronic channel guide information is extracted from a received digital multimedia broadcasting signal.

5. The apparatus as claimed in claim 1, wherein the first display unit displays information regarding another function of the terminal.

6. The apparatus as claimed in claim 2, wherein the control unit comprises:
a phone module; and
a multimedia module,
wherein the phone module controls the first display unit such that the channel information delivered from the multimedia module is displayed on the first display unit.

7. The apparatus as claimed in claim 6, wherein the phone module detects a channel change input of the user and transmits the channel change input to the multimedia module, the multimedia module determines validity of the channel change input and, if the channel change input is valid, transmits channel change information to the phone module, and the phone module displays changed channel information on the first display unit.

8. The apparatus as claimed in claim 6, wherein, if the phone module detects message reception in a state in which the channel information is displayed on the first display unit, the phone module stops displaying the channel information and displays the received message.

9. The apparatus as claimed in claim 2, wherein the control unit comprises:
a phone module; and
a multimedia module,
wherein the multimedia module controls the first display unit such that the channel information is displayed on the first display unit.

10. The apparatus as claimed in claim 9, wherein the multimedia module detects a channel change input of a user, determines validity of the channel change input, and, if the channel change input is valid, displays changed channel information on the first display unit.

11. The apparatus as claimed in claim 9, wherein, if the multimedia module receives notification of message reception from the phone module in a state of displaying the channel information on the first display unit, the multimedia module stops displaying the channel information and displays a received message.

12. A method for displaying digital multimedia broadcasting channel information in a terminal that can receive digital multimedia broadcasting including a first module, a second module, a first display unit, and a second display unit, the first module controlling a first function, the first display unit displaying an image according to execution of the first function, the second module controlling a second function, the second display unit displaying an image according to execution of the second function, the method comprising the steps of:
detecting, by the first module, a digital multimedia broadcasting mode selection of a user;
notifying, by the first module, the second module of the digital multimedia broadcasting mode selection;
determining, by the second module, if electronic channel guide information exists in a memory;
transmitting, by the second module, the electronic channel guide to the first module, if the electronic channel guide information exists in the memory;
creating, by the first module, channel information by using the electronic channel guide information; and
displaying the channel information on the first display unit.

13. The method as claimed in claim 12, further comprising the steps of:
if the user selects a desired channel through the channel information, detecting, by the first module, channel selection of the user;
notifying the second module of the channel selected by the user; and
displaying, by the second module, a digital multimedia broadcasting program corresponding to the channel selected by the user on the second display unit.

14. The method as claimed in claim 12, wherein the first module includes a phone module for controlling a portable telephone function.

15. The method as claimed in claim 12, further comprising the steps of:
determining, by the second module, if a time to update electronic channel guide information arrives, if the memory has no electronic channel guide information; and
extracting new electronic channel guide information from a digital multimedia broadcasting signal, if the time to update the electronic channel guide information arrives.

16. The method as claimed in claim 12, further comprising the steps of:
determining, by the first module, if a message is received in a state in which the channel information is displayed on the first display unit;
if the message is received, stopping, by the first module, display of the channel information; and
controlling the first display unit to display the message.

17. A method for displaying digital multimedia broadcasting channel information in a terminal that can receive digital multimedia broadcasting that includes a first module, a second module, a first display unit, and a second display unit, the first module controlling a first function, the first display unit displaying an image according to execution of the first function, the second module controlling a multimedia function, the second display unit displaying an image according to execution of the multimedia function, the method comprising the steps of:
detecting, by the first module, digital multimedia broadcasting mode selection of a user;
notifying, by the first module, the second module of the digital multimedia broadcasting mode selection;
determining, by the second module, if electronic channel guide information exists in a memory;
creating, by the second module channel, information by using the electronic channel guide information;
transmitting the channel information to the first module, if the electronic channel guide information exists in the memory; and
displaying, by the first module, received channel information on the first display unit.

18. The method as claimed in claim 17, further comprising the steps of:
if the user selects a desired channel through the channel information, detecting, by the first module, channel selection of the user;
notifying the second module of the channel selected by the user; and
displaying, by the second module, a digital multimedia broadcasting program corresponding to the channel selected by the user on the second display unit.

19. The method as claimed in claim 18, further comprising the steps of:
if the second module detects a channel change request of the user during display of the digital multimedia broadcasting program, transmitting, by the second module, channel change information to the first module;
displaying a digital multimedia broadcasting program corresponding to a changed channel on the second display unit;
receiving, by the first module, the channel change information; and
displaying changed channel information on the first display unit.

20. The method as claimed in claim 17, wherein the first module includes a phone module for controlling a portable telephone function.

21. The method as claimed in claim 17, further comprising the steps of:
determining, by the second module, if a time to update electronic channel guide information arrives, if the memory has no electronic channel guide information; and
extracting new electronic channel guide information from a digital multimedia broadcasting signal, if the time to update the electronic channel guide information arrives.

22. The method as claimed in claim 17, further comprising the steps of:
determining, by the first module, if a message is received in a state in which the channel information is displayed on the first display unit;
if the message is received, stopping, by the first module, display of the channel information; and
controlling the first display unit to display the message.

23. A method for displaying digital multimedia broadcasting channel information in a terminal that can receive digital multimedia broadcasting and includes a first display unit and a second display unit, the method comprising the steps of:
detecting a digital multimedia broadcasting mode selection by a user;
determining if electronic channel guide information exists in a memory;
if the electronic channel guide information exists, creating channel information using the electronic channel guide information;
displaying the channel information on the first display unit;
detecting a channel selection by the user; and
displaying a digital multimedia broadcasting program corresponding to the channel selected by the user on the second display unit.

24. The method as claimed in claim 23, further comprising the steps of:
detecting a channel change request of the user during display of the digital multimedia broadcasting program;
displaying a digital multimedia broadcasting program corresponding to the changed channel on the second display unit; and
displaying changed channel information on the first display unit.

25. The method as claimed in claim 23, further comprising the steps of:
determining if a time to update electronic channel guide information arrives, if the electronic channel guide information does not exist in the memory; and
extracting new electronic channel guide information from a received digital multimedia broadcasting signal, if the time arrives.

26. The method as claimed in claim 23, further comprising the steps of:
determining if a message is received in a state in which the channel information is displayed on the first display unit;
stopping display of the channel information; and
displaying a received message on the first display unit, if message reception is detected.

27. A terminal comprising:
a digital multimedia broadcasting module for controlling digital multimedia broadcasting reception;
a first module for controlling a first function;
a first display unit for displaying an image according to the first function and the digital multimedia broadcasting channel information;
a second module for controlling a second function; and
a second display unit for displaying an image according to the second function and the digital multimedia broadcasting program.

28. A terminal comprising:
a digital multimedia broadcasting module for controlling digital multimedia broadcasting reception;
a control module for controlling a predetermined function;
a first display unit for displaying an image according to the predetermined function and the digital multimedia broadcasting channel information according to a control of the control module; and
a second display unit for displaying the digital multimedia broadcasting program according to a control of the control module.

29. The terminal as claimed in claim 28, wherein the control module controls an MP3 player function.

30. The terminal as claimed in claim 28, wherein the control module controls a digital video disc (DVD) player function.

31. The terminal as claimed in claim 28, wherein the control module controls a function for Telemetics.
